(19) United States
(12) Patent Application Publication
(10) Pub. No.: US 2006/0090647 A1
(43) Pub. Date: May 4, 2006

(54) Method of catching nano-particles

(75) Inventors: Chia-Chang Lin, Hsinchu (TW); Shu-Kang Hsu, Hsinchu (TW); Wen-Tzong Liu, Hsinchu (TW); I-Min Tseng, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/002,233

(22) Filed: Dec. 3, 2004

(30) Foreign Application Priority Data
Nov. 2, 2004 (TW) 93133339

(51) Int. Cl. B01D 46/00

(52) U.S. Cl. 95/215

(57) ABSTRACT

The present invention discloses a method for catching particles having diameters size down to the nanometer level including a first step of increasing particle diameters of particles contained in an outlet gas from a fabrication process of nano-particles or an exhaust from a combustion; and a second step of introducing the resulting effluent from the first step into a rotating packed bed. The first step involves contacting the gas/exhaust with droplets or water vapor, creating collision of the nano-particles with the droplets or condensation of water vapor using the nano-particles as condensation nuclei, so that the size of the nano-particles increases to the micro level. The second step uses the minute water drops generated from and the hindrance of the rotating packed bed to catch the micro-particles in the gas/exhaust under a relatively high centrifugal force. The first step can occur in the rotating packed bed if the gas/exhaust is introduced directly into the rotating packed bed and has a sufficient long residence time in the rotating packed bed.

### FIELD OF THE INVENTION

The present invention is related to a method for catching particles having a size down to nanometer, and in particular to a method of using a rotating packed bed to catch nano-particles entrained in an outlet gas from a fabrication process of nano-particles or an exhaust from a combustion.

### BACKGROUND OF THE INVENTION

Nano-particles are often seen in a gaseous carrier in the fabrication process of a nano-material or nano-device, or in an exhaust from a combustion process. Nano-particles have a size ranging from several nanometers to hundred nanometers, and cannot be efficiently collected by the conventional methods such as the cyclone dust collector, electrostatic precipitator, and pocket-type filter.

The recent research on application of a rotating packed bed is rather helpful in finding a solution to the problems which can not be easily resolved in the normal gravity field. The mass transfer process is greatly enhanced by the rotating packed bed in such a way that a 2-meter rotating packed bed can be used in place of a 10-meter packed column, and that the rotating packed bed is exceptionally effective in bringing about an absorption process, a stripping process, or a distillation process, as exemplified by the disclosures of the U.S. Pat. Nos. 4,283,255; 4,382,045; 4,382,900; and 4,400,275. In addition, the Chinese patent publication No. CN1116146A (1996) discloses a process for making ultrafine granule by using the mass transfer equipment in such a manner that a multiphase material flow is fed into the axial position of a rotating packed bed via a distributor from a tubular structure formed of two concentric sleeves. Under the effect of a high gravity field, the material flow comes in contact with the rotating packed bed. Such a technique as described above is relatively new and is still under further investigation. To the best of knowledge of these inventors of the present invention, no prior art dealing with the application of the rotating packed bed to the catching of nano-particles has ever been disclosed. Details of the disclosure in the above-mentioned patents are incorporated herein by referenced.

### SUMMARY OF THE INVENTION

A primary objective of the present invention is to remove nano-particles from a gas phase. Further, the present invention is to provide a method for effectively collecting nano-particles produced in a process of the preparation of nano-particles, and a method for solving the environmental contamination problems caused by the nano-particles entrained in the discharge from the high-tech industries. In order to achieve these objectives, a rotating packed bed is used in the present invention, wherein the rotating speed and the amount of the liquid sprayed into the rotating packed bed can be adjusted according to the size distribution and properties of the particles entrained in the gas stream.

The method of the present invention is a wet catching method using a packing and a high centrifugal force provided by the rotating packed bed, thereby the probability of collision of the liquid droplets and the nano-particles are significantly increased. The experimental data show the method of the present invention is very efficient in catching particles having a size down to nanometer level. The efficiency can be enhanced if the gas stream having nano-particles entrained therein is subjected to a particle size enlargement treatment prior to being introduced into the rotating packed bed, for example over-saturating the gas phase with a vapor. The vapor will condense using the nano-particles as condensation nuclei, so that the sizes of the nano-particles increases.

The method of the present invention improves the drawbacks of the conventional cyclone dust collector, electrostatic precipitator, and pocket-type filter in the collection of nano-particles, because the later cannot create active collision and the rotating packed bed can. This is important to the catching of nano-particles, which involves Brown movement as a major catching mechanism. Accordingly, the method of the present invention can be optimized by adjusting the rotation speed of the rotating packed bed and the amount of the liquid introduced into the rotating packed bed.

The features and the advantages of the method of the present invention will be more readily understood upon a thoughtful deliberation of the following detailed description of the nonrestrictive embodiments with reference to the accompanying drawing.

### BRIEF DESCRIPTION OF THE DRAWING

FIG. 1 shows a schematic diagram of a rotating packed bed system suitable for use in the method of the present invention.

### DETAILED DESCRIPTION OF THE PREFERRED EMBODIMENTS

The present invention discloses a method for catching nano-particles entrained in a gas stream by using a rotating packed bed comprising the following steps:

a) introducing a liquid into an annular rotating packed bed rotating around an axis, said rotating packed bed being located in a housing, so that said liquid flow radially through a packing of said rotating packed bed in a direction away from said axis;

b) introducing a gas stream having particles entrained therein into the rotating packed bed such that the particles entrained in the gas stream are caught by the liquid when the liquid flows radially through the packing, generating a relatively clean gas stream discharged via an exit port on a top of the housing and a particle-containing liquid collected at a bottom of the housing.

Preferably, the method of the present invention further comprises contacting the gas stream having particles entrained therein with droplets or vapor of a solvent before the gas stream having particles entrained therein being introduced into the rotating packed bed, creating collision of the particles with the droplets or condensation of vapor using the particles as condensation nuclei. Preferably, said solvent is water of an aqueous solution.

Preferably, the liquid is fed into the rotating packed bed via an axial area of the rotating packed bed in step a). More preferably, the gas stream having particles entrained therein is introduced into the rotating packed bed via a fringe of the housing, thereby enabling the liquid to contact with the gas having particles entrained therein in such a way that the flow direction of the liquid is opposite to the flow direction of the gas stream having particles entrained therein when the liquid flows radially through the packing; or the gas stream having particles entrained therein is introduced into the rotating packed bed via the axial area of the rotating packed bed, thereby enabling the liquid to contact with the gas having particles entrained therein in such a way that the flow direction of the liquid is the same as the flow direction of the gas stream having particles entrained therein when the liquid flows radially through the packing; or the gas stream having particles entrained therein is introduced into the rotating packed bed at a bottom of the rotating packed bed such that the gas stream is discharged from a top of the rotating packed bed, and that the gas stream and the liquid come into contact with each other at an angle when the liquid flows radially through the packing.

Preferably, the method of the present invention further comprises recycling the relatively clean gas stream discharged via an exit port on a top of the housing in step b) as a whole or partially to the gas stream having particles entrained therein in step a).

Preferably, said liquid is water or an aqueous solution.

Preferably, said gas stream having particles entrained therein is an air stream or a nitrogen gas stream having particles entrained therein.

Preferably, the gas stream having particles entrained therein comprises particles of several nanometers to several hundred nanometers.

Preferably, the gas stream having particles entrained therein comprises an outlet gas from a fabrication process of nano-particles or an exhaust from a combustion.

Preferably, said rotating pack bed comprises a central channel region around said axis and an annular packed region surrounding said central channel region, said annular packed region being packed with said packing, and said annular packed region and said central channel region being in fluid communication only through a boundary thereof, and said annular packed region and said housing being in fluid communication only through an outer circumference of said annular packed region.

Preferably, the exit port on a top of the housing is exerted on by a negative pressure to facilitate the discharge of the relatively clean gas stream.

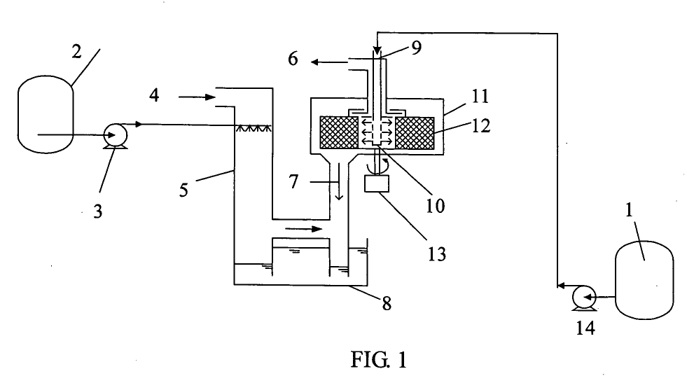

As illustrated in FIG. 1, a gas stream having nano- and micro-particles entrained therein is introduced into a particle-size enlargement zone 5 via a gas inlet 4, which is filled with droplets or vapor from a liquid or vapor supply tank 2 by using a pump 3. The nano-particles contact the droplets or vapor, creating collision of the nano-particles with the droplets or condensation of water vapor using the nano-particles as condensation nuclei, so that the size of a portion of the nano-particles increases to the micro level in the zone 5. The gas stream leaving the zone 5 will enter a housing 11 at the bottom thereof, in which a rotating packed bed is mounted, and then enter an annular pack region 12 of the rotating packed bed at the outer circumferential edge of the annular pack region 12. The annular pack region 12 is packed with a packing. A liquid for catching the particles is kept in a liquid tank 1, from which the liquid is pumped by a pump 14 into the axial area of the rotating packed bed via a liquid inlet 9. By means of a liquid distributor 10, the liquid entering the liquid inlet 9 is uniformly sprayed toward the annular pack region 12, and is caused to rapidly move outward by an enormous centrifugal force which is generated by a variable motor 13. As a result, more minute liquid droplets are created, when the liquid passes the packing of the annular pack region 12. At the same time, the gas stream flowing in the opposite direction will contact the minute liquid droplets, thereby the particles entrained in the gas stream are stripped. The minute liquid droplets carrying the particles will hit the housing 11 and will be collected at the bottom of the housing 11 prior to being discharged via a liquid outlet 7 to a collection tank 8. The resulting clean gas stream is discharged via a gas outlet 6 at the top of the housing 11.

The contents, objectives and features of the present invention are further elaborated by way of the following examples which are for explaining the present invention instead of limiting the scope thereof.

### EXAMPLE 1

In this example a rotating packed bed was used to removal alumina particles in a gas. The gas stream having alumina particles entrained therein was introduced into the rotating packed bed via a gas inlet provided at a circumferential edge of a housing wherein the rotating packed bed was mounted. The test conditions are listed in the following table:

| Rotating packed bed | Parameters |
|---|---|
| Particle type | Alumina |
| Concentration of particle | A total concentration of 8.6 g/m³in the gas |
| | phase |
| Particle size distribution | 82 wt % of the particles are of 1.0˜5.6 μm; the |
| | concentration of particles of 0.56˜1 μm is |
| | 31.4 mg/m³ |
| Packing | stainless steel wires having a diameter of |
| | 0.22 mm |
| Specific surface area of | 603 m²/m³ |
| packing | |
| Voidage of packed bed | 96.7% |
| Inner radius of annular | 6.1 cm |
| packed bed | |
| Outer radius of annular | 14.7 cm |
| packed bed | |
| Axial height of annular | 9.5 cm |
| packed bed | |
| Rotation speed | 400, 800, 1200 and 1600 rpm |
| Gas/liquid (H₂O) ratio | 50 and 100 m³/m³ |

The results are shown in the following table:

| | 400 rpm | | 800 rpm | | 1,200 rpm | | 1,600 rpm | |
|---|---|---|---|---|---|---|---|---|
| Particle | Gas/H₂O | Gas/H₂O | Gas/H₂O | Gas/H₂O | Gas/H₂O | Gas/H₂O | Gas/H₂O | Gas/H₂O |
| size | ratio | ratio | ratio | ratio | ratio | ratio | ratio | ratio |
| μm | 100 L/L | 50 L/L | 100 L/L | 50 L/L | 100 L/L | 50 L/L | 100 L/L | 50 L/L |
| 0.56 | 36.4% | 47.7% | 55.4% | 53.4% | 21.9% | 42.7% | 37.5% | 62.4% |
| 1.0 | 60.3% | 72.6% | 75.2% | 78.1% | 88.1% | 90.1% | 93.3% | 99.3% |
| 1.8 | 64.8% | 70.5% | 84.0% | 91.5% | 100.0% | 99.5% | 100.0% | 99.9% |
| 3.2 | 84.0% | 88.1% | 98.5% | 99.7% | 100.0% | 100.0% | 100.0% | 99.8% |
| 5.6 | 93.8% | 97.2% | 100.0% | 100.0% | 100.0% | 100.0% | 99.9% | 100.0% |
| 10 | 99.9% | 99.8% | 100.0% | 100.0% | 100.0% | 100.0% | 100.0% | 100.0% |
| 18 | 100.0% | 100.0% | 100.0% | 100.0% | 100.0% | 100.0% | 100.0% | 100.0% |

The catching efficiency of particles having a diameter greater than 1.0 μm is 99.3% or higher; and is 62.4% for particles of 0.56˜1.0 μm.

### EXAMPLE 2

In this example a rotating packed bed was used to removal particles in a off gas discharged from a cancination process of a novel metal recovery plant. The off gas stream was introduced into the rotating packed bed via a gas inlet provided at a circumferential edge of a housing wherein the rotating packed bed was mounted. The particle and rotating packed bed conditions are listed in the following table:

| Rotating packed bed | Parameters |
|---|---|
| Particle type | tail gas discharged from a cancination process |
| | of a novel metal recovery plant |
| Concentration of particle | A total concentration of 345˜639 mg/Nm³ in |
| | the gas phase |
| Particle size distribution | 34.7˜38.9 wt % of the particles are smaller |
| | than 1 μm |
| Packing | rhombus expansion net having a thickness of |
| | 0.5 mm and 4 × 8 mm mesh hole |
| Specific surface area of | 150 m²/m³ |
| packing | |
| Voidage of packed bed | 93.7% |
| Inner radius of annular | 150 cm |
| packed bed | |
| Outer radius of annular | 350 cm |
| packed bed | |

The test conditions and results are shown in the following table:

| Rota- | | | | Particle | Particle | |
|---|---|---|---|---|---|---|
| tion | Flow rate | Flow rate | Gas/ | conc. | conc. of | |
| speed | of off gas | of water | H₂O | of off gas | outlet gas | Effi- |
| rpm | m³/hr | m³/hr | ratio | mg/m³ | mg/m³ | ciency % |
| 1,600 | 820 | 3.1 | 265 | 415 | 55 | 86.7 |
| 1,600 | 820 | 2.7 | 304 | 363 | 61 | 83.2 |
| 1,600 | 820 | 1.8 | 456 | 390 | 94 | 75.9 |
| 1,600 | 820 | 0.9 | 911 | 345 | 97 | 71.9 |
| 1,700 | 1,090 | 4.8 | 227 | 639 | 39 | 94.0 |
| 1,700 | 1,090 | 4.8 | 227 | 549 | 34 | 93.9 |
| 1,700 | 1,090 | 4.0 | 273 | 554 | 55 | 90.1 |
| 1,700 | 1,090 | 4.0 | 273 | 567 | 32 | 94.4 |
| 1,750 | 1,060 | 4.8 | 221 | 525 | 29 | 94.4 |
| 1,750 | 1,060 | 4.8 | 221 | 473 | 30 | 93.7 |
| 1,750 | 1,060 | 4.0 | 265 | 514 | 31 | 94.1 |
| 1,780 | 1,060 | 4.8 | 221 | 454 | 30 | 93.5 |

It can be seen from above that the catching efficiency is of 90˜94% for the test conditions of rotation speed of 1,700 rpm or higher; gas/water ratio less than 273; and flow rate of off gas less than 1,090 m³/hr.

Although particular embodiments of the invention have been described, various alternations, modifications, and improvements will readily occur to those skilled in the art. Accordingly, the forgoing description is by way of example only and is not intended as limiting. This invention is limited only as defined in the following claims and the equivalents thereto.

1. A method for catching nano-particles entrained in a gas stream by using a rotating packed bed comprising the following steps:
a) introducing a liquid into an annular rotating packed bed rotating around an axis, said rotating packed bed being located in a housing, so that said liquid flow radially through a packing of said rotating packed bed in a direction away from said axis;
b) introducing a gas stream having particles entrained therein into the rotating packed bed such that the particles entrained in the gas stream are caught by the liquid when the liquid flows radially through the packing, generating a relatively clean gas stream discharged via an exit port on a top of the housing and a particle-containing liquid collected at a bottom of the housing.

2. The method as defined in claim 1 further comprising contacting the gas stream having particles entrained therein with droplets or vapor of a solvent before the gas stream having particles entrained therein being introduced into the rotating packed bed, creating collision of the particles with the droplets or condensation of vapor using the particles as condensation nuclei.

3. The method as defined in claim 1, wherein the liquid is fed into the rotating packed bed via an axial area of the rotating packed bed in step a).

4. The method as defined in claim 3, wherein the gas stream having particles entrained therein is introduced into the rotating packed bed via a fringe of the housing, thereby enabling the liquid to contact with the gas having particles entrained therein in such a way that the flow direction of the liquid is opposite to the flow direction of the gas stream having particles entrained therein when the liquid flows radially through the packing.

5. The method as defined in claim 3, wherein the gas stream having particles entrained therein is introduced into the rotating packed bed via the axial area of the rotating packed bed, thereby enabling the liquid to contact with the gas having particles entrained therein in such a way that the flow direction of the liquid is the same as the flow direction of the gas stream having particles entrained therein when the liquid flows radially through the packing.

6. The method as defined in claim 3, wherein the gas stream having particles entrained therein is introduced into the rotating packed bed at a bottom of the rotating packed bed such that the gas stream is discharged from a top of the rotating packed bed, and that the gas stream and the liquid come into contact with each other at an angle when the liquid flows radially through the packing.

7. The method as defined in claim 1 further comprising recycling the relatively clean gas stream discharged via an exit port on a top of the housing in step b) as a whole or partially to the gas stream having particles entrained therein in step a).

8. The method as defined in claim 1, wherein said liquid is water or an aqueous solution.

9. The method as defined in claim 1, wherein said gas stream having particles entrained therein is an air stream or a nitrogen gas stream having particles entrained therein.

10. The method as defined in claim 1, wherein the gas stream having particles entrained therein comprises particles of several nanometers to several hundred nanometers.

11. The method as defined in claim 1, wherein the gas stream having particles entrained therein comprises an outlet gas from a fabrication process of nano-particles or an exhaust from a combustion.

12. The method as defined in claim 2, wherein said solvent is water of an aqueous solution.

13. The method as defined in claim 1, wherein said rotating pack bed comprises a central channel region around said axis and an annular packed region surrounding said central channel region, said annular packed region being packed with said packing, and said annular packed region and said central channel region being in fluid communication only through a boundary thereof, and said annular packed region and said housing being in fluid communication only through an outer circumference of said annular packed region.

14. The method as defined in claim 4, wherein the exit port on a top of the housing is exerted on by a negative pressure to facilitate the discharge of the relatively clean gas stream.
